(19) United States
(12) Patent Application Publication
(10) Pub. No.: US 2017/0017112 A1
(43) Pub. Date: Jan. 19, 2017

(54) ARRAY SUBSTRATE AND LIQUID CRYSTAL DISPLAY PANEL USING THE SAME

(71) Applicant: SHENXHEN CHINA STAR OPTOELECTRONICS TECHNOLOGY CO. LTD., Shenzhen, Guangdong (CN)

(72) Inventors: Chengliang YE, Shenzhen, Guangdong (CN); Ruhai FU, Shenzhen, Guangdong (CN); Jie QIU, Shenzhen, Guangdong (CN); ChunKai CHANG, Shenzhen, Guangdong (CN); Yunglun LIN, Shenzhen, Guangdong (CN)

(21) Appl. No.: 14/777,977

(22) PCT Filed: Jul. 17, 2015
(86) PCT No.: PCT/CN2015/084364

§ 371 Date: Sep. 17, 2015

(30) Foreign Application Priority Data
Jul. 13, 2015 (CN) 201510410284.6

(51) Int. Cl. G02F 1/1335; G02F 1/1368; G02F 1/1362; G02F 1/1333

(52) U.S. Cl. CPC G02F 1/133514; G02F 1/133345; G02F 1/1368; G02F 1/136286; G02F 1/136209; G02F 2201/123; G02F 2201/121

(57) ABSTRACT

The present invention provides an array substrate and a liquid crystal display panel using the same. The array substrate includes: a base substrate, a first metal layer, a color resist layer, a black matrix layer, a transparent conductive layer. The color resist layer comprises a plurality of color film resists. Adjacent two of the color film resists are disposed with an interval. In the array substrate and the liquid crystal display panel of the present invention, by disposing the color film resists with the interval, an overlap between the color film resists can be avoided, so that the surface of the array substrate is more smooth, and the dark fringes can be reduced.

### TECHNICAL FIELD OF THE INVENTION

The present invention relates to a liquid crystal display (LCD) technology, and in particular to an array substrate and a liquid crystal display panel using the same.

### BACKGROUND OF THE INVENTION

A conventional liquid crystal display panel comprises: a first substrate and a second substrate 19. For example, the first substrate is a BOA (Black Matrix on Array) substrate, the BOA substrate has a color filter substrate and a black matrix formed on an array substrate. The BOA comprises a base substrate 11, a shade metal line 12, an insulating layer 13 located between the shade metal line 12 and the data lines; a data line 14, a color resist layer 15, a black matrix layer 16, a transparent conductive layer 17, and a liquid crystal layer 18. The color resist layer 15 includes a red color film 101, a green color film 102, and a blue color film 103. In order to reduce the coupling capacitance between the data line and the transparent conductive layer, for a liquid crystal display, the shade metal lines 12 are added at both sides of the data line 14, so as to have shielding effect The separation distance between the shade metal line 12 and the data line 14 is about 3-4 microns. BOA technology shields the gap between the data line 14 and the shade metal line 12 by the black matrix.

However, the existing manufacturing methods, above the data line 14, color resists of two adjacent color film resists overlap too thickly, resulting in liquid crystal of pixel edge tilts in direction so that the liquid crystal molecules tilt inconsistent. Especially in the case of the bright state, due to the above influence of thickness difference, dark fringes are generated in the liquid crystal at the edge of a pixel, thereby reducing the contrast of panel. As shown in FIG. 2, the data lines 14 and the scanning lines 20 are defined a plurality of pixels 104, 105. The dark fringes are generated at the edges of pixels 104 and 105.

Therefore, it is necessary to provide a liquid crystal display panel and an array substrate which can solve the problems of the prior art.

### SUMMARY OF THE INVENTION

The purpose of the present invention is to provide an array substrate and a liquid crystal display panel to resolve the technical problems in the prior art due to the overlap between adjacent color film resists, which makes the surface of the array substrate side to be uneven, so that dark fringes are prone to appear.

To solve the above problems, the present invention constructs an array substrate, comprising:
a base substrate;
a shade metal layer, located on the base substrate, the shade metal layer comprising a plurality of shade metal lines;
a first metal layer, located on the shade metal layer, including a plurality of data lines;
a first insulating layer, located on the first metal layer;
a color resist layer located on the first insulating layer, the color resist layer including a plurality of color film resists; wherein adjacent two of the color film resists are disposed with an interval;
a black matrix layer, located between two of the color film resists, the black matrix layer comprising a plurality of black matrices; and
a transparent conductive layer, located on the black matrix layer;

wherein the interval between the adjacent two of the color film resists is set in accordance with a first interval, the first interval is a distance between a first projection and a second projection, the first projection is a projection of the data line projected on the base substrate, and the second projection is a projection of the shade metal line, which corresponds to the data line, projected on the base substrate.

In the array substrate of the present invention, the distance between two adjacent color film resists is 2-4 microns.

In the array substrate of the present invention, the thickness of the black matrix is equal to the thickness of the color film resist.

In the array substrate of the present invention, the black matrix is used for shading a gap between the data line and the shade metal line corresponding thereto.

In the array substrate of the present invention, a second insulating layer is located between the shade metal layer and the first metal layer.

To solve the above problems, the present invention constructs an array substrate, comprising:
a base substrate;
a first metal layer located on the base substrate, comprising a plurality of data lines;
a color resist layer, located on the first metal layer, the color resist layer including a plurality of color film resists; wherein adjacent two of the color film resists are disposed with an interval;
a black matrix layer, located between two of the color film resists, the black matrix layer comprising a plurality of black matrices; and
a transparent conductive layer, located on the black matrix layer.

In the array substrate of the present invention, the array substrate further comprises a shade metal layer, the shade metal layer is located between the base substrate and the first metal layer, the shade metal layer comprises a plurality of shade metal lines;

the interval between the adjacent two of the color film resists is set in accordance with a first interval, the first interval is a distance between a first projection and a second projection, the first projection is a projection of the data line projected on the base substrate, and the second projection is a projection of the shade metal line, which corresponds to the data line, projected on the base substrate.

In the array substrate of the present invention, the distance between two adjacent color film resists is 2-4 microns.

In the array substrate of the present invention, the thickness of the black matrix is equal to the thickness of the color film resist.

In the array substrate of the present invention, the array substrate further comprises a shade metal layer, the shade metal layer is located between the base substrate and the first metal layer, the shade metal layer comprises a plurality of shade metal lines;
the black matrix is used for shading a gap between the data line and the shade metal line corresponding thereto.

In the array substrate of the present invention, a first insulating layer is located between the first metal layer and the color resist layer.

The present invention further provides a liquid crystal display panel, comprising:
an opposed substrate, located opposite an array substrate;
a liquid crystal layer, located between the opposed substrate and the array substrate; and
the array substrate, comprising:
a base substrate;
a first metal layer located on the base substrate, comprising a plurality of data lines;
a color resist layer, located on the first metal layer, the color resist layer including a plurality of color film resists; wherein adjacent two of the color film resists are disposed with an interval;
a black matrix layer, located between two of the color film resists, the black matrix layer comprising a plurality of black matrices; and
a transparent conductive layer, located on the black matrix layer.

In the liquid crystal display panel of the present invention, the array substrate further comprises a shade metal layer, the shade metal layer is located between the base substrate and the first metal layer, the shade metal layer comprises a plurality of shade metal lines;
the interval between the adjacent two of the color film resists is set in accordance with a first interval, the first interval is a distance between a first projection and a second projection, the first projection is a projection of the data line projected on the base substrate, and the second projection is a projection of the shade metal line, which corresponds to the data line, projected on the base substrate.

In the liquid crystal display panel of the present invention, the distance between two adjacent color film resists is 2-4 microns.

In the liquid crystal display panel of the present invention, the thickness of the black matrix is equal to the thickness of the color film resist.

In the liquid crystal display panel of the present invention, the black matrix is used for shading a gap between the data line and the shade metal line corresponding thereto.

In the liquid crystal display panel of the present invention, a first insulating layer is located between the first metal layer and the color resist layer.

In the liquid crystal display panel of the present invention, a second insulating layer is located between the shade metal layer and the first metal layer.

An array substrate and a liquid crystal display panel of the present invention, by disposing the color film resists with the interval, an overlap between the color film resists can be avoided, so that the surface of the array substrate is more smooth and the dark fringes can be reduced.

### BRIEF DESCRIPTION OF THE DRAWINGS

FIG. 1 is a schematic diagram of a structure of an array substrate of the prior art.

FIG. 2 is a schematic diagram of a structure of pixels of the prior art.

FIG. 3 is a schematic diagram of a structure of a first liquid crystal display panel of the present invention.

FIG. 4 is a schematic diagram of a structure of a second liquid crystal display panel of the present invention.

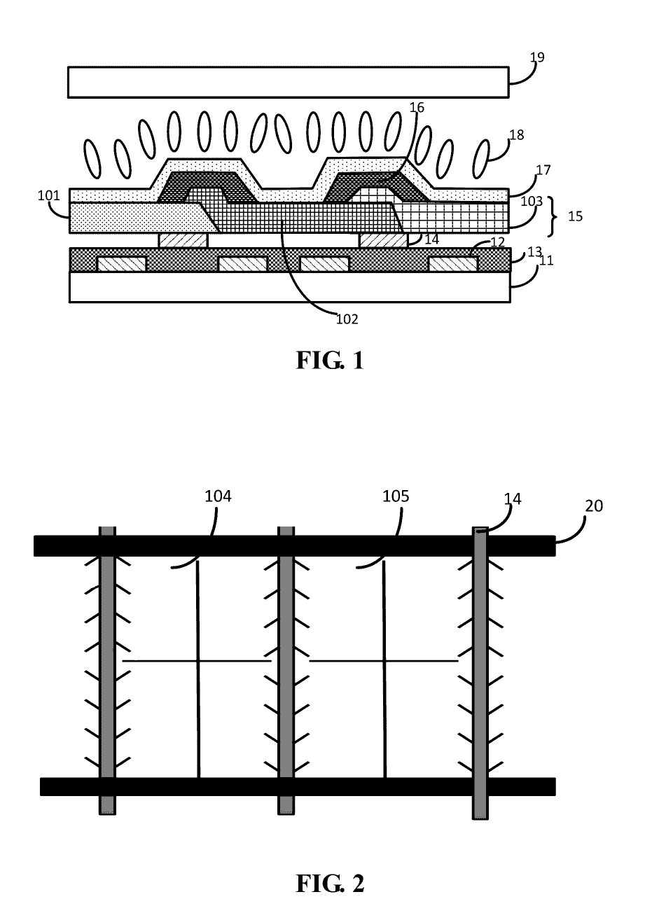

### DETAILED DESCRIPTION OF THE INVENTION

The following descriptions for the respective embodiments are specific embodiments capable of being implemented for illustrations of the present invention with reference to the appended figures. For example, the terms of up, down, front, rear, left, right, interior, exterior, side, etcetera are merely directions referring to the appended figures. Therefore, the wordings of the directions are employed for explaining and understanding the present invention, but are not limitations thereto. In the appended figures, elements having similar structures are represented with the same numeral.

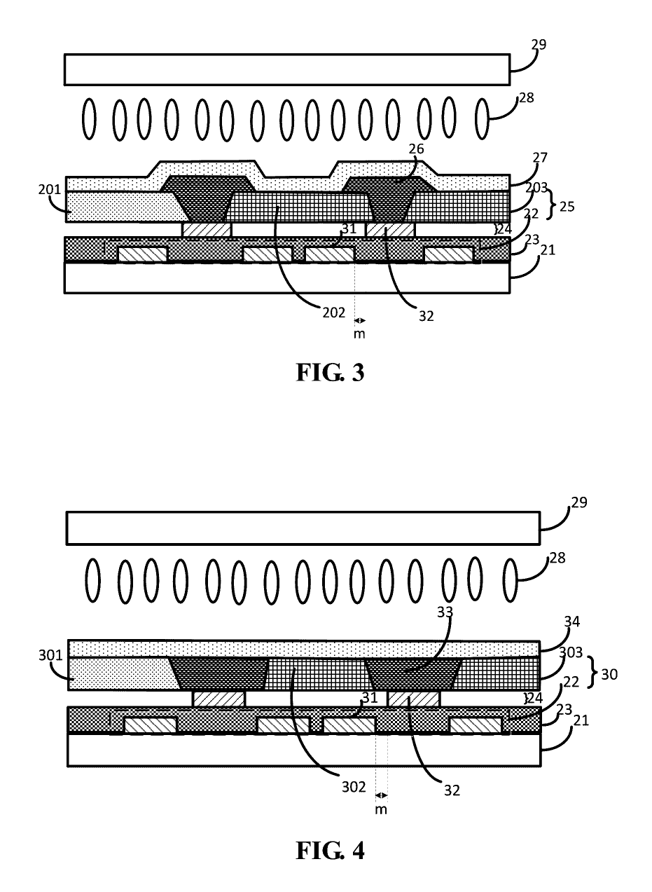

Please refer to FIG. 3. FIG. 3 is a schematic diagram of a structure of a second liquid crystal display panel of the present invention.

The array substrate of the present invention, comprises: a first substrate, the first substrate such as BOA (BM on Array) substrate, wherein BOA comprises a base substrate 21, a first metal layer 24, a color resist layer 25, a black matrix layer, a transparent conductive layer 27, and a liquid crystal layer 28; in addition, furthermore comprises a shade metal layer 22, and a second insulating layer 23, the shade metal layer 22 is located on the base substrate 21, and comprises a plurality of shade metal lines 31, the shade metal lines 31 are used for reducing coupling capacitance between a data line 32 and the transparent conductive layer 27; the color resist layer 25 is located on the first metal layer 24, the color resist layer 25 comprises a plurality of color film resists, such as a red color film 201, a green color film 202, and a blue color film 203. Two adjacent color films resists are disposed with intervals; i.e., there is no overlap between two adjacent color film resists. The black matrix layer is located between two color film resists, the black matrix layer includes a plurality of black matrices 26. The transparent conductive layer 27 includes a pixel electrode.

Since there is no overlap between the color film resists, and therefore in the production of the black matrix, a portion of the black matrix material flows into the gap between color film resists, thus reducing the height of black matrix overlap on the color film resist, such that the surface of the array substrate becomes more smooth, which can be reduced the dark fringes, and improve the contrast of the panel.

Preferably, a distance between two adjacent color film resists is located in accordance with a first pitch, the first pitch is the distance m between a first projection and a second projection, the first projection is projection of the data line 32 projected on the base substrate 21; and the second projection is projection of the shade metal line 31 projected on the base substrate 21, the data line 32 is corresponding to the shade metal line 31. Generally, the shade metal line is disposed beside both sides of the data line.

The distance between the color film resists is preferably larger than the first pitch, if the distance is too small, it will affect the aperture ratio of the panel. Therefore the distance between color film resists is disposed according to the first pitch, which can avoid the impact of the aperture ratio of the display panel.

Preferably, the black matrix is used for shading a gap between the data line and the shade metal line corresponding thereto. For example, a black matrix 26 shields the gap between the data line 26 and the shade metal line 31 located on itself left side, and shields the gap between the data line 26 and the shade metal line 31 itself right side.

Preferably, the distance between two adjacent color film resists is 2-4 microns. The smaller the distance between the color film resists, the higher the height of the black matrix overlap on the color film resists. The surface of an array substrate becomes more uneven, resulting in more dark fringes. Too large of a pitch reduces light transmittance and the utilization of the panel.

Preferably, a plurality of thin film transistors are furthermore disposed on the array substrate, each color film resist is corresponding to one thin film transistor.

Preferably, a first insulating layer is disposed between the first metal layer and the color resist layer. The first insulating layer is used for isolating the shade metal layer and the color resist layer, used to prevent the shade metal layer from oxidation.

Please refer to FIG. 4. FIG. 4 is a schematic diagram of a structure of a second liquid crystal display panel of the present invention.

The difference between the last embodiment and the embodiment of the present embodiment is: in the color resist layer 30 of the present embodiment, the distance between a red color film 301, a green color film 302, or a blue color film 303 is larger than the distance of FIG. 3,

so that the black the black matrix layer 33 thickness and the color film resists 301-303 thickness are of equal thickness; the surface of the color film resists, and the surface of the black matrix are flush, thus making the surface of the transparent conductive layer 34 to be more smooth.

The present embodiment does not overlap the black matrix on color film resist, thus making the surface of the array substrate the more smooth which can be further reduced dark fringes.

The present invention further provides a liquid crystal display panel, comprising: as shown in FIGS. 3 and 4, an opposed substrate 29, located opposite an array substrate; a liquid crystal layer 28, located between the opposed substrate and the array substrate; and the array substrate, comprising: a base substrate 21; the shade metal layer 22 is located on base substrate 21, comprising a plurality of shade metal lines 31; the shade metal lines 31 being used to reduce the coupling capacitance between the data line 32 and the transparent conductive layer 27 or 34, the shade metal layer 22 can be disposed with a common electrode.
a first metal layer 24 located on the shade metal layer 22, comprising a plurality of data lines 32;
a color resist layer 25 or 30, located on the first metal layer 24, the color resist layer including a plurality of color film resist 201-203 or 301-303; wherein adjacent two of the color film resists are disposed with an interval;
a black matrix layer, located between two of the color film resists, the black matrix layer comprising a plurality of black matrices 26 or 33; and
a transparent conductive layer 27 or 34, located on the black matrix layer.

Preferably, the interval between the adjacent two of the color film resists is set in accordance with a first interval, the first interval is a distance between a first projection and a second projection, the first projection is a projection of the data line projected on the base substrate, and the second projection is a projection of the shade metal line, which corresponds to the data line, projected on the base substrate.

The distance between the color film resists is preferably larger than the first pitch, if the distance is too small, it will affect the aperture ratio of the panel. Therefore the distance between color film resists is disposed according to the first pitch, which can avoid the impact of the aperture ratio of the display panel.

Preferably, the black matrix is used for shading a gap between the data line and the shade metal line corresponding thereto. For example, a black matrix 26 shields the gap between the data line 26 and the shade metal line 31 located on itself left side, and shields the gap between the data line 26 and the shade metal line 31 itself right side.

Preferably, the distance between two adjacent color film resists is 2-4 microns.

The smaller the distance between the color film resists, the higher the height of the black matrix overlap on the color film resists. The surface of an array substrate becomes more uneven, resulting in more dark fringes. Too large of a pitch reduces light transmittance and the utilization of the panel.

Preferably, a plurality of thin film transistors are furthermore disposed on the array substrate, each color film resist is corresponding to one thin film transistor.

Preferably, a first insulating layer is disposed between the first metal layer and the color resist layer. The first insulating layer is used for isolating the shade metal layer and the color resist layer, and used to prevent the shade metal layer from oxidation.

An array substrate and a liquid crystal display panel of the present invention, by disposing the color film resists with the interval, an overlap between the color film resists can be avoided, so that the surface of the array substrate is more smooth and the dark fringes can be reduced.

In summary, although the present invention has been described in preferred embodiments above, the preferred embodiments described above are not intended to limit the invention. One of ordinary skill in the art without departing from the spirit and scope of the invention can make all species of modifications and variations, so the protection scope of the invention is defined by the claims.

What is claimed is:

1. An array substrate, comprising:
a base substrate;
a shade metal layer, located on the base substrate, the shade metal layer comprising a plurality of shade metal lines;
a first metal layer, located on the shade metal layer, including a plurality of data lines;
a first insulating layer, located on the first metal layer;
a color resist layer, located on the first insulating layer, the color resist layer including a plurality of color film resists, wherein adjacent two of the color film resists are disposed with an interval;
a black matrix layer, located between two of the color film resists, the black matrix layer comprising a plurality of black matrices; and
a transparent conductive layer, located on the black matrix layer;
wherein the interval between the adjacent two of the color film resists is set in accordance with a first interval, the first interval is a distance between a first projection and a second projection, the first projection is a projection of the data line projected on the base substrate, and the second projection is a projection of the shade metal line, which corresponds to the data line, projected on the base substrate.

2. The array substrate according to claim 1, wherein the interval between the adjacent two of the color film resists is 2-4 microns.

3. The array substrate according to claim 1, wherein a thickness of the black matrix is equal to a thickness of the color film resist.

4. The array substrate according to claim 1, wherein the black matrix is used for shading a gap between the data line and the shade metal line corresponding thereto.

5. The array substrate according to claim 1, further comprising a second insulating layer located between the shade metal layer and the first metal layer.

6. An array substrate, comprising:
a base substrate;
a first metal layer located on the base substrate, comprising a plurality of data lines;
a color resist layer, located on the first metal layer, the color resist layer including a plurality of color film resists; wherein adjacent two of the color film resists are disposed with an interval;
a black matrix layer, located between two of the color film resists, the black matrix layer comprising a plurality of black matrices; and
a transparent conductive layer, located on the black matrix layer.

7. The array substrate according to claim 6, wherein the array substrate further comprises a shade metal layer, the shade metal layer is located between the base substrate and the first metal layer, the shade metal layer comprises a plurality of shade metal lines;
the interval between the adjacent two of the color film resists is set in accordance with a first interval, the first interval is a distance between a first projection and a second projection, the first projection is a projection of the data line projected on the base substrate; and the second projection is a projection of the shade metal line, which corresponds to the data line, projected on the base substrate.

8. The array substrate according to claim 6, wherein the distance between two adjacent color film resists is 2-4 microns.

9. The array substrate according to claim 6, wherein the thickness of the black matrix is equal to the thickness of the color film resist.

10. The array substrate according to claim 6, wherein the array substrate further comprises a shade metal layer, the shade metal layer is located between the base substrate and the first metal layer, the shade metal layer comprises a plurality of shade metal lines;
the black matrix is used for shading a gap between the data line and the shade metal line corresponding thereto.

11. The array substrate according to claim 6, wherein a first insulating layer is located between the first metal layer and the color resist layer.

12. A liquid crystal display panel, comprising:
an opposed substrate, located opposite an array substrate;
a liquid crystal layer, located between the opposed substrate and the array substrate; and
the array substrate, comprising:
a base substrate;
a first metal layer located on the base substrate, comprising a plurality of data lines;
a color resist layer, located on the first metal layer, the color resist layer including a plurality of color film resists; wherein adjacent two of the color film resists are disposed with an interval;
a black matrix layer, located between two of the color film resists, the black matrix layer comprising a plurality of black matrices; and
a transparent conductive layer, located on the black matrix layer.

13. The liquid crystal display panel according to claim 12, wherein the array substrate further comprises a shade metal layer, the shade metal layer is located between the base substrate and the first metal layer, the shade metal layer comprises a plurality of shade metal lines;
the interval between the adjacent two of the color film resists is set in accordance with a first interval, the first interval is a distance between a first projection and a second projection, the first projection is a projection of the data line projected on the base substrate; and the second projection is a projection of the shade metal line, which corresponds to the data line, projected on the base substrate.

14. The liquid crystal display panel according to claim 12, wherein the distance between two adjacent color film resists is 2-4 microns.

15. The liquid crystal display panel according to claim 12, wherein the thickness of the black matrix is equal to the thickness of the color film resist.

16. The liquid crystal display panel according to claim 12, wherein the black matrix is used for shading a gap between the data line and the shade metal line corresponding thereto.

17. The liquid crystal display panel according to claim 12, wherein a first insulating layer is located between the first metal layer and the color resist layer.

18. The liquid crystal display panel according to claim 12, wherein a second insulating layer is located between the shade metal layer and the first metal layer.
